(19) United States
(12) Patent Application Publication
(10) Pub. No.: US 2026/0227938 A1
(43) Pub. Date: Aug. 6, 2026

(54) PRINT SYSTEM WITH SIMPLIFIED USER OPERATION

(71) Applicant: Toshiba Tec Kabushiki Kaisha, Tokyo (JP)

(72) Inventor: Kosei SAEKI, Mishima Shizuoka (JP)

(21) Appl. No.: 19/422,110

(22) Filed: Dec. 16, 2025

(30) Foreign Application Priority Data
Feb. 6, 2025 (JP) 2025-018639

(51) Int. Cl. G06F 3/12

(52) U.S. Cl. CPC G06F 3/1238; G06F 3/1204; G06F 3/1222; G06F 3/1231; G06F 3/1288

(57) ABSTRACT

According to one embodiment, a server for a print system includes a storage unit with a print job list, a communication interface, and a processor. The processor receives a job list transmission request from a client terminal via the communication interface, then transmits the print job list to the client terminal in response to the request. A lock state release code is transmitted to a printer of the system to cause the printer to output the lock state release code. The processor receives a print job selection and a print job release request from the client terminal. The print job release request includes the lock state release code obtained by the client terminal from the printer. Based on the print job selection and the print job release request, the server causes the printer to perform a print job corresponding to the print job selection.

### CROSS-REFERENCE TO RELATED APPLICATION

This application is based upon and claims the benefit of priority from Japanese Patent Application No. 2025-018639, filed February 6, 2025, the entire contents of which are incorporated herein by reference.

### FIELD

Embodiments described herein relate generally to a print system including a server providing simplified user operations for performing a print job.

### BACKGROUND

In general, an image output system including an information processing terminal, a server, and a multi-function printer is known. In such an image output system, a user operates the information processing terminal to log in to the system. Then, the user operates the information processing terminal to photograph a code pattern displayed on the multi-function printer. When the user operates a print button on the information processing terminal, the information processing terminal transmits the acquired information of the code pattern and authentication information to the server. The server identifies the multi-function printer based on the information in the code pattern, and instructs execution of a printing process.

### BRIEF DESCRIPTION OF THE DRAWINGS

FIG. 1 depicts a print system according to an embodiment.

FIG. 2 is a block diagram showing an example of an internal configuration of components of a print system according to an embodiment.

FIG. 3 depicts aspects of a device registration list and an account registration file according to an embodiment.

FIG. 4 depicts a schematic functional configuration implemented by a processor of a server according to an embodiment.

FIG. 5 depicts an example of an operation sequence.

FIG. 6 depicts an example of an operation sequence.

FIG. 7 depicts an example of a reading screen.

FIG. 8 is a diagram showing an example of a print job selection screen.

FIG. 9 is a flowchart showing an example of operations of a client terminal according to an embodiment.

FIG. 10 is a flowchart showing an example of operations of a server according to an embodiment.

FIG. 11 is a flowchart showing an example of operations of a printer according to an embodiment.

### DETAILED DESCRIPTION

In a print system, there is a demand for simplifying user operations. For example, when a user wants to cause a printer to execute printing of a target print file, the user may currently operate a user interface of the printer to select the target print file, but there is a demand to avoid requiring the user to operate the user interface of the printer to print the target print file. An embodiment described herein provides a server, a print system, and a method for simplifying user operations for printing target files and the like.

In general, according to one embodiment, a server for a print system includes a storage unit for storing a print job list associated with a user account, a communication interface connectable to a client terminal and a printer, and a processor. The processor is configured to receive a job list transmission request from the client terminal via the communication interface, transmit the print job list to the client terminal via the communication interface in response to the job list transmission request, transmit a lock state release code to the printer via the communication interface to cause the printer to output the lock state release code, receive a print job selection and a print job release request from the client terminal, the print job release request including the lock state release code obtained by the client terminal from the printer, and, based on the print job selection and the print job release request, cause the printer to perform a print job corresponding to the print job selection.

Hereinafter, certain example embodiments will be described with reference to the drawings. In the description, components having substantially the same function and configuration are denoted by the same reference symbols. The example embodiments are provided to illustrate technical concepts of the disclosure but do not limit the disclosure. For example, the details of the described example embodiments that may be related to specific materials adopted, component shapes, types and structures, and arrangements thereof, are not limitations unless stated as such. The example embodiment can be modified in various ways and each such modification is within the scope of the present disclosure.

### Configuration

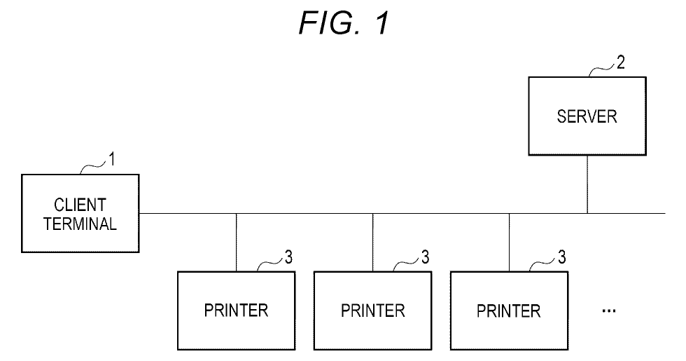

FIG. 1 is a diagram showing an example of a network configuration of devices constituting a print system according to an example embodiment. As shown in FIG. 1, the print system includes a client terminal 1, a server 2 that functions as a print server, and at least one printer 3. The printer 3 can be any device that generates an image based on print data sent from the server 2. The client terminal 1, the server 2, and the printer(s) 3 are connected via a communication network.

For example, as shown in FIG. 1, a plurality of printers 3 are connected to the communication network. Although FIG. 1 shows an example in which one client terminal 1 is connected to the communication network, this is not a limitation and two or more client terminals 1 can be simultaneously connected to a network of the print system.

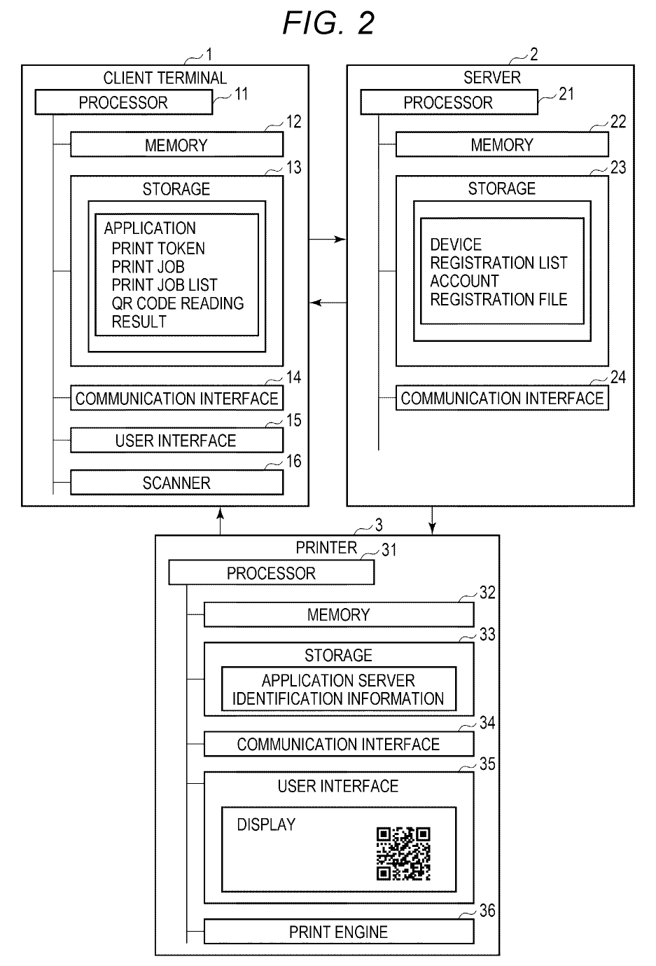

FIG. 2 is a block diagram showing an example of an internal configuration of devices constituting the print system according to this embodiment. The client terminal 1 can be implemented as a computer including one or more processors, a memory, a storage, and an interface. As shown in FIG. 2, the client terminal 1 includes a processor 11, a memory 12, a storage 13, a communication interface 14, a user interface 15, and a scanner 16.

The processor 11 is implemented as a central processing unit (CPU) or the like. The processor 11 executes various processes based on a control program and control data that are stored in the memory 12. For example, the processor 11 executes a print support application program stored in the memory 12 to cause the printer 3 to execute a print process via the server 2.

The memory 12 includes a read only memory (ROM), a random access memory (RAM), and a non-volatile memory (NVM). The ROM and the NVM store a control program, control data, and the like. The RAM functions as a work memory and stores temporary data.

The storage 13 stores print data and the like. The storage 13 may store a control program, control data, and the like.

The communication interface 14 wirelessly communicates with the server 2 and transmits and receives data to and from the server 2.

The user interface 15 comprises an input unit and an output unit. For example, the input unit and the output unit are configured as a touch panel display that receives an input from a user (operator) and displays received information.

The scanner 16 is an optical device or the like that reads a one-dimensional code or a two-dimensional code. A bar code is one example of a one-dimensional code, and a quick response (QR) code is one example of a two-dimensional code.

The server 2 can be implemented as a computer including one or more processors, a memory, a storage, and an interface. As shown in FIG. 2, the server 2 includes a processor 21, a memory 22, a storage 23, and a communication interface 24.

The processor 21 comprises a CPU or the like. The processor 21 executes various processes based on a control program and control data that are stored in the memory 22. For example, the processor 21 controls transmission and reception of information by the communication interface 24 by executing a program stored in the memory 22, and causes the printer 3 to print an image based on a print job in response to a request from the client terminal 1.

The memory 22 includes a ROM, a RAM, and an NVM. The ROM and the NVM store a control program, control data, and the like. The RAM functions as a work memory and stores temporary data.

The memory 22 and/or the storage 23 stores a device registration list and an account registration file. The device registration list includes printer identification information of each printer 3 registered in the print system. The account registration file includes account information necessary for using a print service provided by the print system. Furthermore, generally before device shipment, the server identification information is stored in the storage 23, and the server identification information can be transmitted to each printer 3 which has been registered in the print system. The storage 23 may also store a control program, control data, and the like. In the present embodiment, a case where the storage 23 stores the device registration list and the account registration file will be described, but as described above, the NVM of the memory 22 may instead or also store the device registration list and the account registration file.

The communication interface 24 wirelessly communicates with the client terminal 1 and transmits and receives data to and from the client terminal 1. The communication interface 24 wirelessly communicates with the printer 3 and transmits and receives data to and from the printer 3.

As shown in FIG. 2, the printer 3 includes a processor 31, a memory 32, a storage 33, a communication interface 34, a user interface 35, and a print engine 36.

The processor 31 comprises a CPU or the like. The processor 31 executes various processes based on a control program and control data that are stored in the memory 32. For example, the processor 31 acquires print data from the server 2 by executing a print application program stored in the memory 32, and causes the print engine 36 to execute image formation based on the print data.

The memory 32 includes a ROM, a RAM, and an NVM. The ROM and the NVM store a control program, control data, and the like. The RAM functions as a work memory and stores temporary data.

The storage 33 stores print data and the like. The storage 33 may store a control program, control data, and the like.

The communication interface 34 wirelessly communicates with the server 2 and transmits and receives data to and from the server 2.

The user interface 35 comprises an input unit and an output unit. For example, the input unit and the output unit are configured as a touch panel display to receive an input from a user (operator) and display received information. For example, the user interface 35 displays a QR code when appropriate.

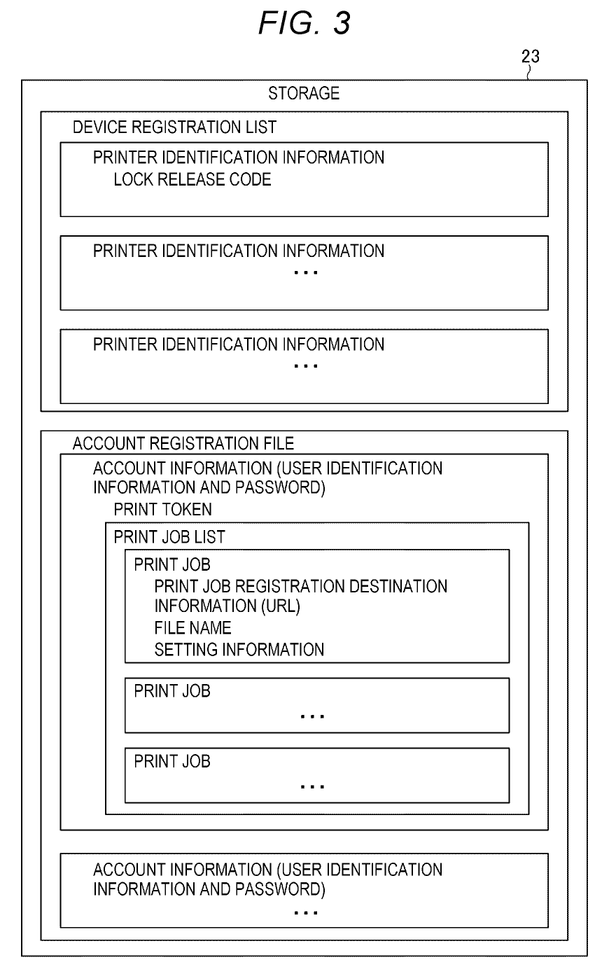

FIG. 3 is a diagram showing an example of a device registration list and an account registration file according to the embodiment. As shown in FIG. 3, the storage 23 of the server 2 stores a device registration list and an account registration file.

In the device registration list, printer identification information of each printer 3 registered in the print system is entered. The printer identification information of each printer 3 is associated with a lock release code.

The account information reflects the information associated with each registered user of the print system. An entry for each registered user in the print system is included in the account registration file. The account information for each registered user includes user identification information and a password. The account information of a user is also associated with a print job list and a print token. The print job list may include a plurality of print jobs as separate entries. The associated details of each listed print job includes a print job registration destination information (URL), a file name, and print job settings (“setting information”). In other words, the print job entry includes the name of a file to be printed, an address of an area where the file is stored, and the printer settings to be used when printing the file. That is, the print job is a set of information necessary for the printer 3 to execute a printing of a file according to the user selections or preferences, and the print job list is the set of print jobs to be performed.

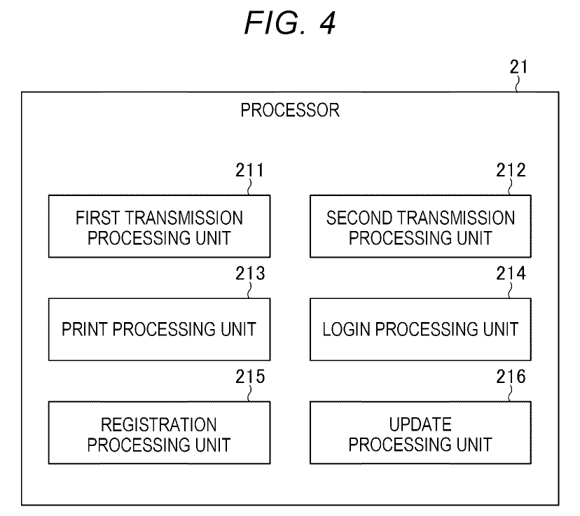

FIG. 4 is a diagram showing an example of functional units implemented by a processor of a server according to an embodiment. As shown in FIG. 4, the processor 21 of the server 2 implements a first transmission processing unit 211, a second transmission processing unit 212, a print processing unit 213, a login processing unit 214, a registration processing unit 215, and an update processing unit 216 as functional units. In general, such functional units can be implemented by the execution of software instructions to perform the described operations, functions, and/or processes associated with the functional unit. However, in some examples, certain described operations, functions, and/or processes may be provided by, or in conjunction with, dedicated hardware and/or circuits.

The first transmission processing unit 211 transmits a print job list to the client terminal 1 in response to a job list transmission request transmitted from the client terminal 1.

The second transmission processing unit 212 transmits the lock release code to the printer 3.

The print processing unit 213 releases a lock state of the printer 3 based on the lock release code and a job list selection result indicating the print job selected from the print job list transmitted from the client terminal 1, and causes the printer 3 to execute the print job corresponding to the job list selection result.

The login processing unit 214 verifies a login request transmitted from the client terminal 1 and transmits a print token to the client terminal 1 if the login request is valid.

The registration processing unit 215 transmits registration destination information to the client terminal 1 in response to a print job registration request transmitted from the client terminal 1.

The update processing unit 216 updates a print job list according to a print job transmitted from the client terminal 1 to an address corresponding to the registration destination information.

### Operations

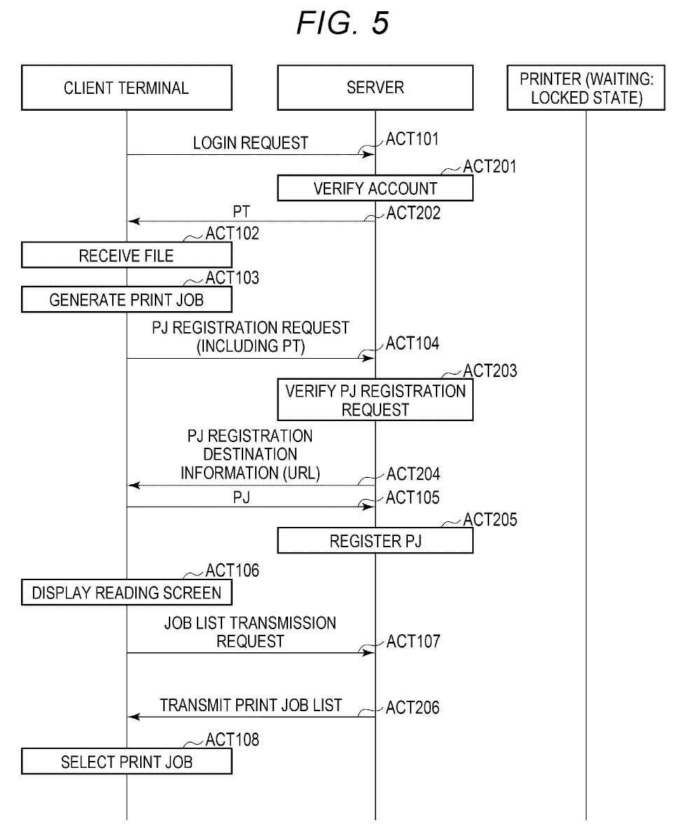

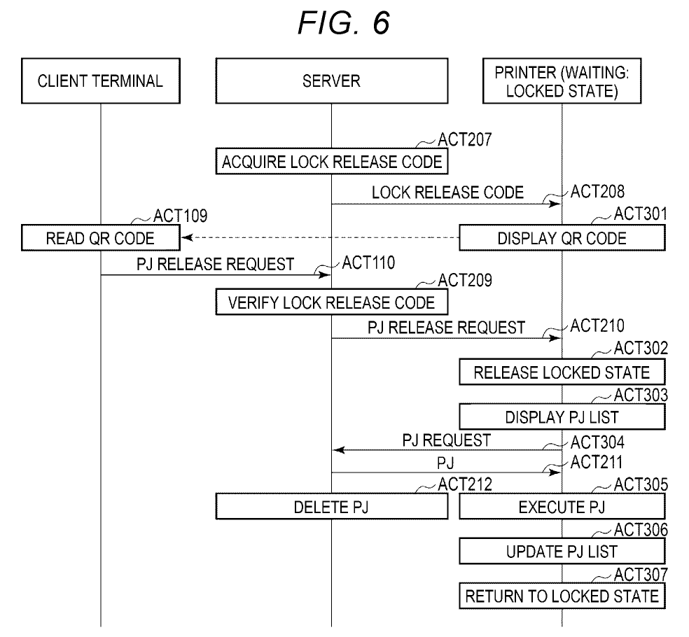

FIGS. 5 and 6 are diagrams each showing an example of an operation sequence of the print system according to an embodiment. Operations of the print system according to an embodiment will be described with reference to FIGS. 5 and 6.

When the main power supply of each of the client terminal 1, the server 2, and the printer 3 of the print system is turned on, the client terminal 1, the server 2, and the printer 3 transitions to a standby state. In this standby state, the printer 3 enters a locked state under the control of its processor 31. In the locked state, the user interface 35 will not receive (accept) an input of an operation from a user, and the print engine 36 does not execute print jobs.

The initial registration of the printer 3 in the print system will be described. The user interface 35 of the printer 3 receives an input of information related to the server 2 from a system administrator or the like. The storage 33 of the printer 3 stores the input information that is related to the server 2. The information related to the server 2 includes server identification information.

The communication interface 34 of the printer 3 transmits a device registration request to the server 2. The device registration request includes printer identification information of the printer 3. The communication interface 24 of the server 2 receives the device registration request. The processor 21 of the server 2 verifies the device registration request. The storage 23 of the server 2 stores a device registration list. When the registration of the printer 3 is permitted based on the verification result of the registration request, the processor 21 generates a lock release code in association with the printer identification information, registers the printer identification information in the device registration list of the storage 23 as shown in FIG. 3, and registers the lock release code in association with the printer identification information.

Registration of an account (user account) in the print system will be described. The use of the print service provided by the print system requires the user to perform an account registration. For example, the user interface 15 of the client terminal 1 of the user displays a new registration menu of the account, and acquires user identification information and a password via the new registration menu. The communication interface 14 of the client terminal 1 transmits the account information including the user identification information and the password to the server 2. The storage 23 of the server 2 stores an account registration file. The communication interface 24 of the server 2 receives the account information. The processor 21 of the server 2 registers the account information in the account registration file.

As shown in FIG. 3, a print token and a print job list are associated with each user’s account information. In the account registration file of each user, a print token and a print job list associated with the account information are registered.

After the registration of the account information is completed, the user interface 15 of the client terminal 1 displays a login menu and acquires user identification information and a password via the login menu. The communication interface 14 of the client terminal 1 transmits a login request including the user identification information and the password to the server 2 (ACT101).

The communication interface 24 of the server 2 receives a login request from the client terminal 1. The processor 21 of the server 2 compares the user identification information and the password included in the login request with the user identification information and the password registered in the account registration file, and verifies the account (ACT201).

The processor 21 permits the login if the combination of the user identification information and password included in the login request matches a combination of user identification information and password registered in the account registration file. The processor 21 rejects the login otherwise.

When permitting the login request based on the account information from the client terminal 1, the processor 21 issues a print token (PT) registered in association with the account information. For example, the print token includes an authentication code. It can be said that the print token is information indicating that a login process has been successfully completed by the client terminal 1. The communication interface 24 transmits the print token to the client terminal 1 (ACT202). The storage 23 stores a token issuance file, and the processor 21 registers the issued print token or data corresponding to the issued print token in the token issuance file and prepares for verification of the print token.

The communication interface 14 of the client terminal 1 receives the print token. The storage 13 stores the received print token. The user interface 15 now displays a print target file selection menu and receives the user’s selection of one or more print target files via the print target file selection menu (ACT102). Further, the user interface 15 displays a print setting menu and receives the user’s selections for printer settings via the print setting menu (ACT102). The selected one or more print target files may be files already stored in the storage 13 or files to be downloaded from an external server via a network. The printer settings are parameters (selections) related to how the printing of the print target file will be performed. For example, print settings provide information such as the number of copies to be printed, a paper sheet size to use, whether to use color printing or monochrome printing, double-sided printing or single-sided printing, whether to use a stapling function or not on a multipage document.

The storage 13 stores a print job file, and the processor 11 stores, in the print job file, a print job including a print target file and print settings. The processor 11 generates a print job corresponding to the selection of a print target file (ACT103). For example, when two print target files are selected, the processor 11 generates a first print job including a first print target file and its print settings and a second print job including a second print target file and its print settings. The processor 11 assigns a separate job identification code to each print job, and manages/tracks the print jobs by job identification code.

The communication interface 14 transmits the print job registration request to the server 2 (ACT104). The print job registration request includes a print token (PT).

The communication interface 24 receives the print job registration request. The processor 21 compares the print token included in the print job registration request with the print token registered in the token issuance file (or data corresponding to the print token), and verifies the print job registration request (ACT203) on this basis.

When the print token included in the print job registration request matches a print token registered in the token issuance file, or when authentication is obtained with the print token included in the print job registration request and the data corresponding to the print token, the processor 21 permits the print job registration. When the print token included in the print job registration request does not match a print token registered in the token issuance file, or when authentication is not obtained with the print token included in the print job registration request and the data corresponding to the print token, the processor 21 rejects the print job registration.

When the print job registration is permitted, the processor 21 determines a registration destination for the print job based on the print token. Specifically, the processor 21 identifies the account corresponding to the print token included in the print job registration request. Then, the processor 21 selects, from the account registration file, the print job registration destination information registered in the print job list corresponding to the identified account. For example, the print job registration destination information specifies a predetermined area of the storage 23 to be used. The processor 21 transmits, to the client terminal 1, print job registration destination information for specifying a predetermined area of the storage 23 in response to the print job registration request received in ACT104. Accordingly, the communication interface 24 transmits the print job registration destination information to the client terminal 1 (ACT204).

For example, the print job registration destination information is a uniform resource locator (URL). The processor 21 sets one registration destination for each print job. The processor 21 sets a different registration destination for each of the print jobs.

The communication interface 14 receives the print job registration destination information, and the storage 13 stores the print job registration destination information. The storage 13 also stores the print token transmitted from the server 2. Further, the communication interface 14 transmits a print job to the server 2 (ACT105).

The communication interface 24 receives the print job, and the processor 21 registers the received print job (print data) in a predetermined area indicated by the print job registration destination information, registers the received print job in the print job list of the appropriate account registration file, and updates the print job list (ACT205). The print token transmitted in ACT202 is registered in the account registration file, and at this time, the print job list in which the received print job is registered and the print token transmitted in ACT202 are also registered in the account registration file.

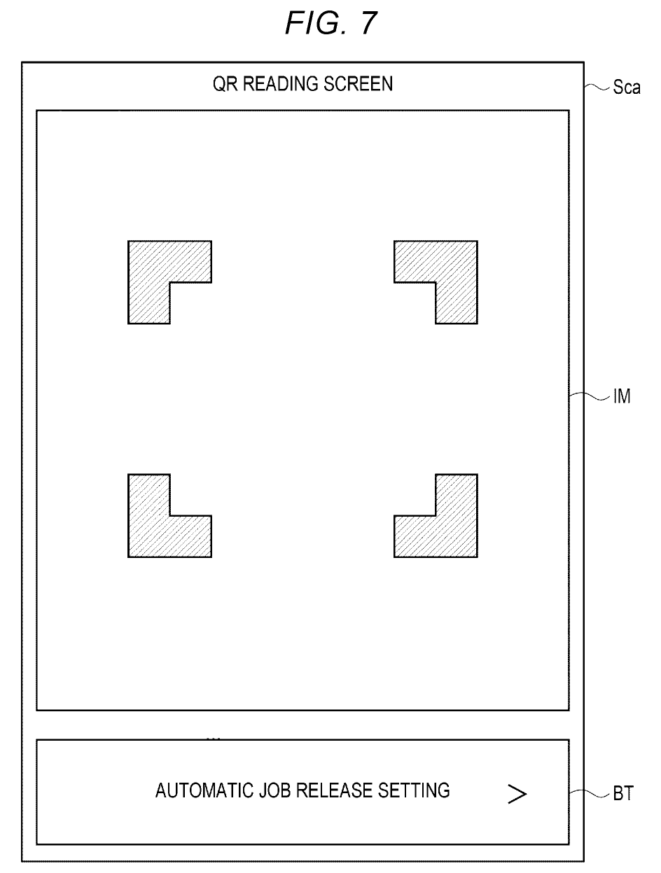

When the registration of the print job is completed, the user interface 15 of the client terminal 1 displays a reading screen in response to a user operation (ACT106). FIG. 7 is a diagram showing an example of a reading screen in the print system according to an embodiment. As shown in FIG. 7, the user interface 15 displays a reading screen Sca. The reading screen Sca includes an area IM and a transition button BT. In the area IM, a one-dimensional code or a two-dimensional code to be read by the scanner 16 is displayed. In the example shown in FIG. 7, neither a one-dimensional code nor a two-dimensional code is displayed at present, and only a frame serving as a guide for scanner 16 is displayed for reading a two-dimensional code. The transition button BT is an icon or the like to be selected for transitioning the display to a screen for setting an automatic job release when pressed by the user. The automatic job release is a function of automatically executing a print job when the lock of the printer 3 is released.

When the transition button BT is pressed by the user, the communication interface 14 of the client terminal 1 transmits a job list transmission request to the server 2 (ACT107). The job list transmission request is a command for requesting transmission of the latest print job list associated with the current logged-in user of the client terminal 1. The job list transmission request includes a print token.

The communication interface 24 of the server 2 receives the job list transmission request. The processor 21 compares the print token included in the job list transmission request with the print token registered in the token issuance file or data corresponding to the print token, and verifies the job list transmission request.

When the print token included in the job list transmission request matches the print token registered in the token issuance file, or when authentication is obtained with the print token included in the job list transmission request and the data corresponding to the print token, the processor 21 permits the transmission of the print job list. When the print token included in the job list transmission request does not match the print token registered in the token issuance file, or when authentication is not obtained with the print token included in the job list transmission request and the data corresponding to the print token, the processor 21 rejects the transmission of the print job list.

When the transmission of the print job list is permitted, the processor 21 controls the storage 23 to access account information of the corresponding user from the account registration file and read the print job list. The communication interface 24 transmits the read print job list to the client terminal 1 (ACT206).

The communication interface 14 of the client terminal 1 receives the print job list. The storage 13 stores the received print job list. The user interface 15 displays a print job selection screen based on the print job list stored in the storage 13, and allows the user to select a print job (ACT108).

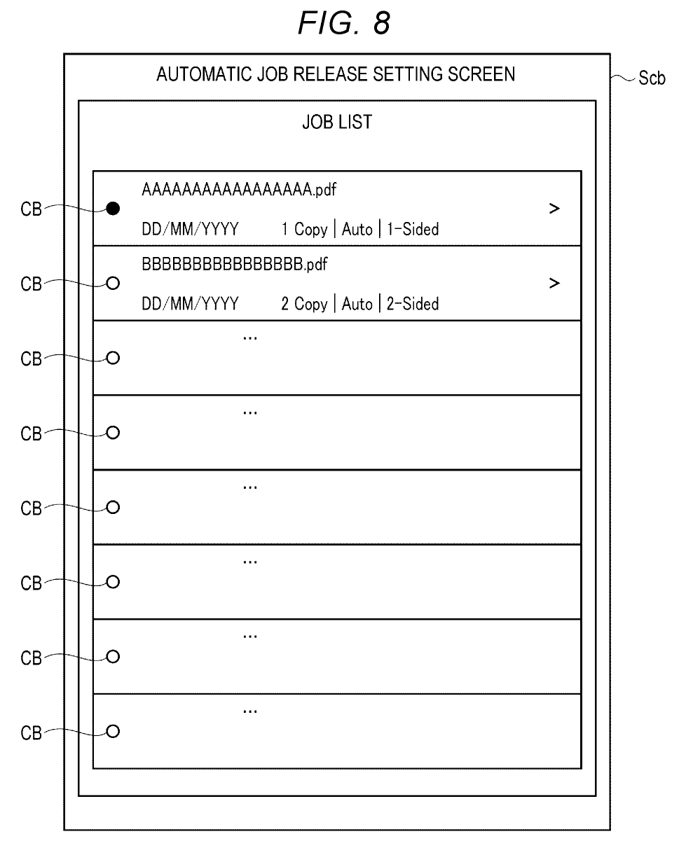

FIG. 8 is a diagram showing an example of a print job selection screen in the print system according to an embodiment. As shown in FIG. 8, a print job selection screen Scb includes a plurality of check boxes CB. The print job selection screen Scb displays a list of print jobs included in the print job list. Each of the print jobs is provided with a corresponding check box CB. When the user touches the check box CB, the check box CB is switched from a non-selected state to a selected state or from the selected state to the non-selected state. The user switches a desired print job to a selected state by touching the check box CB. The user may select only one print job or a plurality of print jobs. The user may select none of the print jobs. The processor 11 causes the storage 13 to store a selection result of the user from the print job list based on a state of the check boxes CB. That is, the selection result of the user corresponds to one or more selected print jobs. When the selection and storage of the print job(s) are completed, the user interface 15 switches the display to a reading screen.

After the user selects the print job, the processor 21 of the server 2 selects the device registration list based on the printer identification information of the printer 3 to be accessed, and acquires a lock release code associated with the printer identification information from the device registration list (ACT207). In the print system, the acquisition of the lock release code and the transmission of the lock release code can be performed for each of the plurality of printers 3 included in the print system. In order to simplify the description, in the examples shown in FIGS. 5 and 6, only a process related to a printer 3 from which the client terminal 1 reads the QR code will be described.

The processor 21 identifies the printer 3 based on the printer identification information associated with the lock release code. The processor 21 transmits the lock release code to the specified printer 3. Accordingly, the communication interface 24 transmits the lock release code to the specified printer 3 (ACT208).

The communication interface 34 of the printer 3 receives the lock release code, and the storage 33 stores the lock release code. The processor 31 generates print designation information based on the server identification information and the lock release code. The print designation information generated in this manner includes the server identification information and the lock release code. For example, the print designation information is a one-dimensional code such as a barcode or a two-dimensional code such as a QR code. The display of the user interface 35 displays the print designation information including the server identification information and the lock release code (ACT301). For example, the display displays a QR code corresponding to the print designation information.

The user interface 15 of the client terminal 1 displays a reading screen. When the user of the client terminal 1 points the scanner 16 at the display of the printer 3, the scanner 16 reads the print designation information displayed on the display (ACT109).

The processor 11 generates a print job release request RA corresponding to the print designation information read by the scanner 16. The communication interface 14 transmits the print job release request RA to the server 2 (ACT110). The print job release request RA includes a reading result of the print designation information, the stored print token, and the print job registration destination information corresponding to the selection result. Here, the print job registration destination information corresponding to the selection result can correspond to one or a plurality of print jobs. That is, if the number of print jobs selected by the user is one, the print job registration destination information is singular, but if the number of print jobs selected by the user is plural, the print job registration destination information is plural. The print job release request RA includes the server identification information and the lock release code included in the print designation information. It may be optional in some examples that the print job release request RA includes the print job registration destination information corresponding to the selection result. When the print job release request RA includes these pieces of information, an automatic release process is realized. If the print designation information is a QR code, the reading result of the print designation information includes a value obtained from the QR code.

The communication interface 24 of the server 2 receives the print job release request RA from the client terminal 1. The processor 21 verifies the lock release code based on the device registration list, the account registration file, and the print job release request RA (ACT209), and specifies a print job list and one printer 3. As shown in FIG. 3, the device registration list includes a lock release code associated with the printer identification information. As shown in FIG. 3, the account registration file includes a print token and a print job list associated with the account information. The print job release request RA includes server identification information, a lock release code, a print token, and print job registration destination information corresponding to the selection result. It may be optional in some examples that the print job release request RA includes the print job registration destination information corresponding to the selection result.

When the lock release code included in the print job release request RA matches the lock release code associated with the printer identification information of the device registration list, the processor 21 permits release of the print job. The processor 21 searches the account registration file for a print token that matches the print token included in the print job release request RA, and specifies the print job list from the account information associated with the searched print token. The processor 21 searches the device registration list for a lock release code that matches the lock release code included in the print job release request RA, specifies the printer identification information associated with the searched lock release code, and specifies one printer 3 from the specified printer identification information. The processor 21 causes the specified printer 3 to print a document or the like based on a print job registered in a registration destination based on the print job registration destination information corresponding to the selection result. A process in which the processor 21 causes the specified printer 3 to print the document based on the print job is realized as follows.

First, the processor 21 causes the communication interface 24 to transmit the print job release request RB to the specified printer 3. Accordingly, the communication interface 24 transmits the print job release request RB to the specified printer 3 (ACT210). The print job release request RB transmitted in ACT210 includes the print job list specified from the account information. The print job release request RB may include print job registration destination information corresponding to the selection result.

The communication interface 34 of the printer 3 receives the print job release request RB transmitted in ACT210. The processor 31 releases the locked state based on the print job release request RB (ACT302). When the lock is released, the user interface 35 can receive an operation input, and the print engine 36 can execute a print job.

The user interface 35 displays the print job list included in the print job release request RB (ACT303). Further, the user interface 35 may display automatic release or automatic printout together with the print job list. Thus, the user can recognize the automatic release or the automatic printout.

The processor 31 detects the print job registration destination information corresponding to the print job list or the selection result included in the print job release request RB. The processor 31 transmits the print job request according to the print job registration destination information corresponding to the print job list or the selection result. Accordingly, the communication interface 34 transmits the print job request to the server 2 (ACT304).

The communication interface 24 of the server 2 receives the print job request from the printer 3. The processor 21 causes the communication interface 24 to transmit the print job registered in the registration destination to the specified printer 3. Accordingly, the communication interface 24 transmits the print job registered in the registration destination to the printer 3 (ACT211).

The communication interface 34 of the printer 3 acquires the print job. The print engine 36 executes printing based on the acquired print job (ACT305). After the printing is completed, the processor 31 updates the print job list (ACT306). Upon detecting a user completion operation or non-operation period of a predetermined time, the processor 31 displays a lock screen and returns to the locked state (ACT307). The processor 31 requests the server 2 to issue a new lock release code and generates another QR code corresponding to the print designation information.

The processor 21 of the server 2 deletes the print job transmitted to the printer 3 (ACT212).

As described above, since the selection operation of the print job for print output in the printer 3 is omitted, the operation load on a user can be reduced.

Here, a case where no print job is selected when the user operates the user interface 15 to select a print job as shown in ACT108 will be described from the process of ACT110. Duplicate description will be omitted as appropriate.

In this case, when forming the print job release request RA, the processor 11 does not include print job registration destination information corresponding to a user selection result. By configuring the print job release request RA in this way, a manual release rather than automatic release is realized.

The communication interface 24 of the server 2 receives the print job release request RA. The processor 21 of the server 2 verifies the lock release code (ACT209), and specifies the print job list and one printer 3. The processor 21 transmits the print job release request RB to the specified printer 3 (ACT210).

When the received print job release request RB does not include the print job registration destination information, the processor 31 of the printer 3 detects a manual release request.

The processor 31 of the printer 3 releases the locked state based on the print job release request RB (ACT302). The user interface 35 displays the print job list included in the print job release request RB (ACT303). Here, the user interface 35 waits for the user to select a print job from the print job list.

Once the user selects the print job, the processor 31 transmits the print job request according to the selection result of the user (ACT304). The subsequent steps are the same as those described for the automatic release example.

As described above, by operating the user interface 35 of the printer 3, a desired print job can be output by manual release.

The processor 21 of server 2 functions as the first transmission processing unit 211 by executing ACT206 in FIGS. 5 and 6. That is, in response to the job list transmission request transmitted from the client terminal 1, the processor 21 controls the storage 23 to read a print job list and controls the communication interface 24 to transmit the print job list to the client terminal 1.

The processor 21 of server 2 functions as the second transmission processing unit 212 by executing ACT208 in FIGS. 5 and 6. That is, the processor 21 specifies the printer 3 and controls the communication interface 24 to transmit the lock release code to the specified printer 3.

The processor 21 of server 2 functions as the print processing unit 213 by executing ACT209, ACT210, and ACT211 in FIGS. 5 and 6. That is, based on the print job release request RA transmitted from the client terminal 1, the processor 21 transmits the print job release request RB to the printer 3 to release the lock, transmits the print job to the printer 3, and thus causes the printer 3 to execute the print job that was selected by the user.

The processor 21 of server 2 functions as the login processing unit 214 by executing ACT201 and ACT202 in FIGS. 5 and 6. That is, the processor 21 verifies a login request from the client terminal 1, and transmits the print token to the client terminal 1 if the login request is valid.

The processor 21 of the server 2 functions as the registration processing unit 215 by executing ACT203 and ACT204 in FIGS. 5 and 6. That is, the processor 21 verifies the print job registration request from the client terminal 1 and transmits the print job registration destination information to the client terminal 1.

The processor 21 of the server 2 functions as the update processing unit 216 by executing ACT205 and ACT212 in FIGS. 5 and 6. That is, the processor 21 registers the received print job in the predetermined area indicated by the print job registration destination information, registers the received print job in the print job list, and updates the print job list. Further, after causing the printer 3 to print the print job corresponding to the job list selection result, the processor 21 deletes the print job corresponding to the job list selection result from the print job list.

The printer 3 implements its described functions in the print system by executing, for example, the processes of ACT301 to ACT305 in FIGS. 5 and 6. That is, in the locked state, the printer 3 receives the lock release code from the server 2, displays the print designation information including the lock release code on the display, releases the locked state based on a command, and prints the print job corresponding to the job list selection result.

The client terminal 1 implements its described functions in the print system by executing, for example, the processes of ACT107 to ACT110 in FIGS. 5 and 6. That is, the client terminal 1 transmits a job list transmission request for requesting a print job list to the server, stores a job list selection result indicating a print job selected from the print job list, reads the print designation information displayed on the printer 3, and transmits the job list selection result and the lock release code to the server 2.

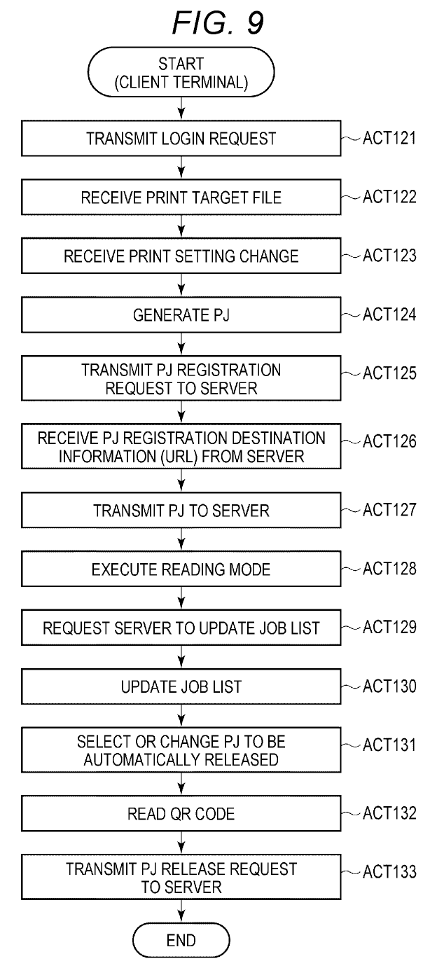

FIG. 9 is a flowchart showing an example of operations of the client terminal 1 according to an embodiment. Since the operations described in conjunction FIG. 9 generally correspond to the operations of the client terminal 1 already described in conjunction with FIGS. 5 and 6, the present description will be somewhat simplified.

The user interface 15 of the client terminal 1 displays the login menu at a start. The communication interface 14 transmits, to the server 2, a login request including the user identification information and the password input via the login menu (ACT121).

After the login is permitted by the server 2, the user interface 15 displays a print target file selection menu, and receives a selection of one or more print target files via the print target file selection menu (ACT122).

The user interface 15 next displays a print setting menu and receives a print setting via the print setting menu (ACT123).

The processor 11 generates a separate print job (PJ) corresponding to the selection of each print target file (ACT124).

The communication interface 14 transmits the print job registration request to the server 2 (ACT125) and then receives the print job registration destination information transmitted from the server 2 (ACT126).

The communication interface 14 transmits the print job to the server 2 based on the print job registration destination information (ACT127).

The user interface 15 executes a reading mode in response to the user operation (ACT128).

In response to the user pressing the transition button BT on the reading screen, the processor 11 requests the server 2 to update the job list (ACT129).

The processor 11 updates the job list based on the print job list received from the server 2 (ACT130).

The user interface 15 displays a print job selection screen based on the updated job list, and allows the user to select and change a print job to be automatically released (ACT131).

When the operation by the user is completed, the user interface 15 switches the display to a reading screen. When the user holds the client terminal 1 (scanner 16) over the QR code displayed on the display of the printer 3, the scanner 16 reads the QR code displayed on the display (ACT132).

The processor 11 generates the print job release request RA corresponding to the reading of the print designation information including the lock release code provided by the scanner 16. The communication interface 14 transmits the configured print job release request RA to the server 2 (ACT133). The print job release request RA includes, in addition to the lock release code and the like, print job registration destination information (when the user selects a print job). When the print job release request RA includes the print job registration destination information (when the user selects a print job), automatic release is performed.

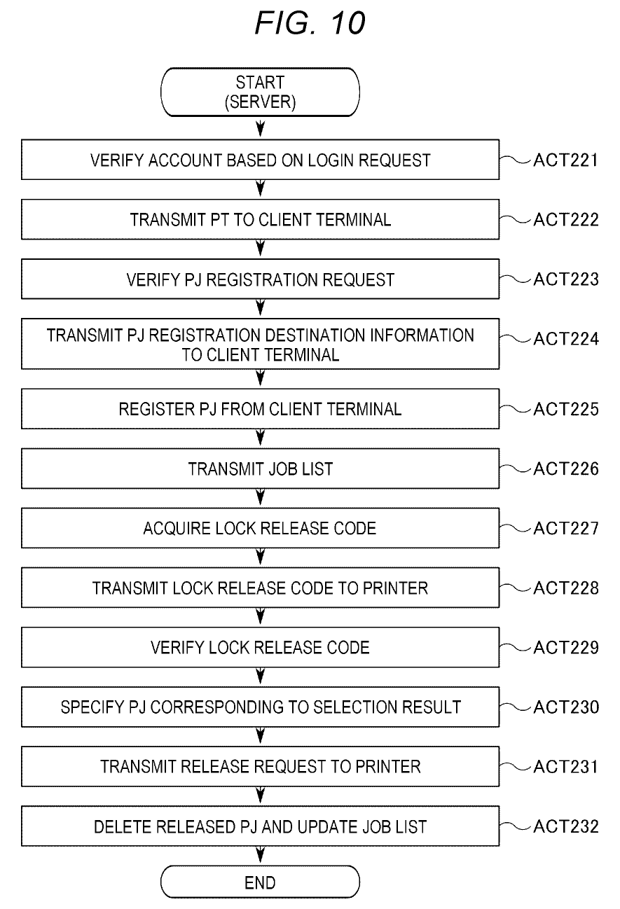

FIG. 10 is a flowchart showing an example of operations of the server 2 according to an embodiment. Since the operations described in conjunction with FIG. 10 correspond in general to the operations of the server 2 already described in conjunction with FIGS. 5 and 6, the description will be partially simplified. In FIG. 10, a case where the automatic release is executed will be described.

The communication interface 24 receives a login request from the client terminal 1. The processor 21 compares the user identification information and the password included in the login request with the user identification information and the password registered in the account registration file, and verifies the account (ACT221).

When the processor 21 permits (authenticates) the login, the communication interface 24 transmits the print token to the client terminal 1 (ACT222) and then receives the print job registration request.

The processor 21 verifies the print job registration request based on the print token included in the received print job registration request (ACT223).

When the print job registration is permitted according to the verification result of the print job registration request, the processor 21 determines a registration destination of the print job. The communication interface 24 transmits print job registration destination information indicating a registration destination of a print job to the client terminal 1 (ACT224), and receives a print job from the client terminal 1.

The processor 21 registers the received print job in the predetermined area indicated by the print job registration destination information (ACT225).

The communication interface 24 receives the job list transmission request from the client terminal 1. The processor 21 verifies the job list transmission request. When the transmission of the print job list is permitted, the communication interface 24 transmits the print job list to the client terminal 1 (ACT226).

After transmitting the print job list, the processor 21 acquires print designation information of the print job (ACT227).

The communication interface 24 transmits the print designation information to the printer 3 specified based on the printer identification information associated with the lock release code (ACT228). The print designation information may include a print job list.

The specified printer 3 displays the print designation information. The client terminal 1 reads the displayed print designation information and transmits the print job release request RA.

The communication interface 24 receives the print job release request RA. The processor 21 verifies the lock release code based on the device registration list, the account registration file, and the print job release request RA (ACT229).

The processor 21 specifies the print job to be released based on the print job registration destination information corresponding to the selection result included in the print job release request RA (ACT230). Then, the communication interface 24 transmits the print job release request RB to the specified printer 3 (ACT231).

After transmitting the print job release request RB, the communication interface 24 receives, from the printer 3, a print job request for requesting the print job registered in the registration destination, and transmits the print job registered in the registration destination to the printer. Then, the processor 21 updates the print job list by deleting the released print job (ACT232).

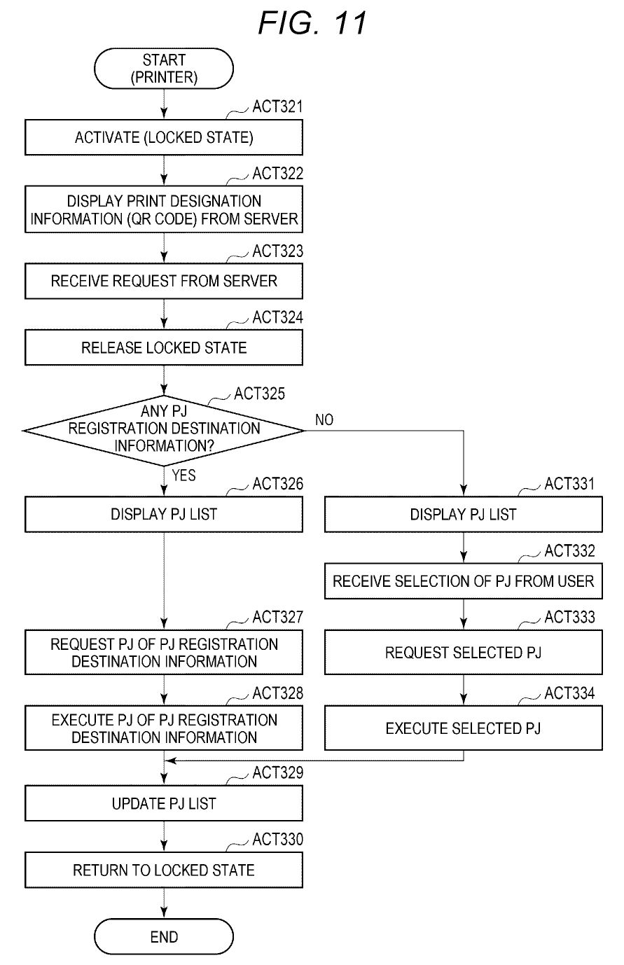

FIG. 11 is a flowchart showing an example of operations of the printer according to an embodiment. Since the operations described in conjunction with FIG. 11 correspond in general to the operations of the printer 3 described in conjunction with FIGS. 5 and 6, the description will be partially simplified.

The printer 3 enters a locked state after activation (ACT321). The communication interface 34 receives the print designation information transmitted from the server 2, and the display of the user interface 35 displays the print designation information (ACT322). The displayed print designation information is, for example, a QR code and can be read by the scanner 16 of the client terminal 1.

The communication interface 34 receives the print job release request RB transmitted from the server 2 (ACT323).

The processor 31 releases the locked state based on the print job release request RB (ACT324).

If the print job release request RB is received and the print job registration destination information is included, the print job release request RB includes the print job list and the registration destination information of the print job (ACT325, YES). The user interface 35 displays the print job list included in the print job release request RB (ACT326).

The processor 31 detects the print job registration destination information corresponding to the selection result included in the print job release request RB. In response to the detection of the print job registration destination information, the communication interface 34 transmits a print job request corresponding to the print job registration destination information to the server 2 (ACT327).

The server 2 receives the print job request from the printer 3 and transmits, to the printer 3, the print job registered in the registration destination. The communication interface 34 acquires a print job. The print engine 36 executes printing based on the acquired print job (ACT328). After the printing is completed, the processor 31 updates the print job list (ACT329). Upon detecting a user completion operation or a non-operation over a predetermined time , the processor 31 displays a lock screen and returns to the locked state (ACT330).

In ACT325, if the print job release request RB is received but the print job registration destination information is not included, the print job release request RB includes the print job list but not the registration destination information of print jobs (ACT325, NO). The user interface 35 displays the print job list included in the print job release request RB (ACT331) and receives the print job selection of the user from the print job list (ACT332).

The communication interface 34 transmits, to the server 2, a print job request for requesting a print job selected from the print job list (ACT333).

The server 2 receives the print job request from the printer 3, and transmits, to the printer 3, the print job corresponding to the user selection from the print job list from among the print jobs registered in the registration destination.

The communication interface 34 acquires a print job. The print engine 36 executes printing based on the acquired print job (ACT334). After the printing is completed, the processor 31 updates the print job list (ACT329).

### Effects

According to an embodiment, the server 2 transmits the print job list to the client terminal 1 in response to the job list transmission request that is transmitted from the client terminal 1. The server 2 transmits the lock release code to the printer 3, releases the lock of the printer 3 based on the job list selection result indicating the print job selected from the print job list and the lock release code transmitted from the client terminal 1, and causes the printer 3 to execute the print job corresponding to the job list selection result. Accordingly, when the user selects a desired print job via the client terminal 1, the user can cause the printer 3 to execute the desired print job simply by reading the print designation information of the printer 3 using the client terminal 1. Since the user does not have to separately perform a selection operation of the print job on the printer 3 before print output, the operation load on the user for print output can be reduced.

According to an embodiment, the job list selection result corresponds to one or more selected print jobs. That is, the user may select multiple print jobs. Accordingly, when the user wants to execute a plurality of print jobs, the user can execute these print jobs without performing a separate operation for each print job. Therefore, the operation load for print output can be reduced.

### Other Modifications

In an embodiment, a QR code is used to provide the print designation information and is read by the scanner 16 of the client terminal 1. The print designation information is not limited to being supplied by a one-dimensional code or a two-dimensional code, and for example, a character string or a numerical string may be used. When a character string, a numerical string, or the like is used as the print designation information, the user may cause the scanner 16 to read the print designation information provided in this manner, or the user may input the print designation information (e.g., the character string or numerical string) by operating the user interface 15 to type in the information.

A software program or the like according to an embodiment may be transferred by being pre-stored in an electronic device such as the client terminal 1, the server 2, and/or the printer 3 or may be transferred separately from these electronic devices. In the latter case, the program may be transferred via a network or in a storage medium. In this context, the storage medium is a computer-readable, non-transitory tangible medium of some type. In general, the storage medium may be of any type or format as long as it can store the program and is readable by a computer, such as an optical disk or a memory card. The electronic device may download a program transferred (provided) via a network and install the program in memory, or read the program from the storage medium and install the program.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A server for a print system, the server comprising:
a storage unit for storing a print job list associated with a user account;
a communication interface connectable to a client terminal and a printer; and
a processor configured to:
receive a job list transmission request from the client terminal via the communication interface;
transmit the print job list to the client terminal via the communication interface in response to the job list transmission request;
transmit a lock state release code to the printer via the communication interface to cause the printer to output the lock state release code;
receive a print job selection and a print job release request from the client terminal, the print job release request including the lock state release code obtained by the client terminal from the printer; and
based on the print job selection and the print job release request, cause the printer to perform a print job corresponding to the print job selection.

2. The server according to claim 1, wherein the lock release code is output by the printer as a visible code displayed on a display screen of the printer to be read by a scanner unit of the client terminal.

3. The server according to claim 1, wherein the processor is further configured to:
receive a print job instruction from the client terminal via the communication interface and register the print job instruction as a print job entry on the print job list associated with the client terminal.

4. The server according to claim 3, wherein the print job instruction indicates a storage location of a file to be printed according to the print job instruction.

5. The server according to claim 3, wherein the print job instruction includes printer settings to be used according to print job instruction.

6. The server according to claim 1, wherein the print job selection designates a plurality of selected print jobs.

7. The server according to claim 1, wherein the processor is further configured to:
receive the print job release request from the client terminal without the print job selection and then transmit the print job list to the printer to cause the printer to display the print job list in a user selectable manner.

8. The server according to claim 1, wherein the processor is further configured to:
receive a login request from the client terminal via the communication interface and associate the client terminal with the user account if the login request is authenticated and then transmit the print job list to the printer to cause the printer to display the print job list in a user selectable manner.

9. The server according to claim 8, wherein the processor is further configured to:
transmit a print token to the client terminal via the communication interface if the login request is authenticated.

10. A print system, comprising:
a printer connected to a network; and
a server including:
a storage unit storing a print job list associated with a user account;
a communication interface connected to the network; and
a processor configured to:
receive a job list transmission request from a client terminal via the communication interface across the network;
transmit the print job list to the client terminal via the communication interface in response to the job list transmission request;
transmit a lock state release code to the printer via the communication interface to cause the printer to output the lock state release code;
receive a print job selection and a print job release request from the client terminal, the print job release request including the lock state release code obtained by the client terminal from the printer; and
based on the print job selection and the print job release request, cause the printer to perform a print job corresponding to the print job selection.

11. The print system according to claim 10, wherein the lock release code is output by the printer as a visible code displayed on a display screen of the printer to be read by a scanner unit of the client terminal.

12. The print system according to claim 10, wherein the processor is further configured to:
receive a print job instruction from the client terminal via the communication interface and register the print job instruction as a print job entry on the print job list associated with the client terminal.

13. The print system according to claim 12, wherein the print job instruction indicates a storage location of a file to be printed according to the print job instruction.

14. The print system according to claim 12, wherein the print job instruction includes printer settings to be used according to print job instruction.

15. The print system according to claim 10, wherein the print job selection designates a plurality of selected print jobs.

16. The print system according to claim 10, wherein the processor is further configured to:
receive the print job release request from the client terminal without the print job selection and then transmit the print job list to the printer to cause the printer to display the print job list in a user selectable manner.

17. The print system according to claim 10, wherein the processor is further configured to:
receive a login request from the client terminal via the communication interface and associate the client terminal with the user account if the login request is authenticated and then transmit the print job list to the printer to cause the printer to display the print job list in a user selectable manner.

18. The print system according to claim 17, wherein the processor is further configured to:
transmit a print token to the client terminal via the communication interface if the login request is authenticated.

19. A print system, comprising:
a plurality of printers connected to a network;
a client terminal connected to the network; and
a server including:
a storage unit storing print job lists associated with user accounts;
a communication interface connected to the network; and
a processor configured to:
receive a job list transmission request from the client terminal via the communication interface across the network;
transmit a print job list to the client terminal via the communication interface in response to the job list transmission request;
transmit a lock state release code to a printer of the plurality of printers via the communication interface to cause the printer to output the lock state release code;
receive a print job selection and a print job release request from the client terminal, the print job release request including the lock state release code obtained by the client terminal from the printer; and
based on the print job selection and the print job release request, cause the printer to perform a print job corresponding to the print job selection.

20. The print system according to claim 19, wherein the lock release code is output by the printer as a visible code displayed on a display screen of the printer to be read by a scanner unit of the client terminal.
